(19) United States
(12) Patent Application Publication
(10) Pub. No.: US 2025/0196318 A1
(43) Pub. Date: Jun. 19, 2025

(54) MOBILE ROBOT, SERVER, AND MOBILE ROBOT CONTROL METHOD

(71) Applicant: Panasonic Intellectual Property Management Co., Ltd., Osaka (JP)

(72) Inventors: Takahiro YAMAGUCHI, Osaka (JP); Yoshinobu KOUNO, Fukuoka (JP); Yoshihiro UJIIE, Tokyo (JP); Tomoyuki HAGA, Nara (JP)

(73) Assignee: Panasonic Intellectual Property Management Co., Ltd., Osaka (JP)

(21) Appl. No.: 19/071,433

(22) Filed: Mar. 5, 2025

Related U.S. Application Data
(63) Continuation of application No. PCT/JP2023/030619, filed on Aug. 24, 2023.

(30) Foreign Application Priority Data
Sep. 12, 2022 (JP) 2022-144691
Mar. 9, 2023 (JP) 2023-036902

(51) Int. Cl. B25J 5/00; B25J 9/16; B25J 13/08

(52) U.S. Cl. CPC B25J 5/007; B25J 9/161; B25J 9/1676; B25J 13/08

(57) ABSTRACT

A mobile robot that is capable of autonomous movement includes: a safe area obtainer that, when an anomaly in the mobile robot is detected during autonomous movement of the mobile robot, obtains information on a safe area identified based on a state of surroundings of the mobile robot, the safe area being an area at which the mobile robot can stop; and a controller that, when an anomaly in the mobile robot is detected during autonomous movement of the mobile robot, causes the mobile robot to move to the safe area based on the information on the safe area.

### CROSS REFERENCE TO RELATED APPLICATIONS

This is a continuation application of PCT International Application No. PCT/JP2023/030619 filed on Aug. 24, 2023, designating the United States of America, which is based on and claims priority of Japanese Patent Application No. 2022-144691 filed on Sep. 12, 2022 and Japanese Patent Application No. 2023-036902 filed on Mar. 9, 2023. The entire disclosures of the above-identified applications, including the specifications, drawings and claims are incorporated herein by reference in their entirety.

### FIELD

The present disclosure relates to a mobile robot, a server, and a mobile robot control method.

### BACKGROUND

Due to labor shortages and an increase in logistics, the adoption of autonomous trucks and mobile robots for autonomous delivery is expected to increase, and their importance is growing. Unlike conventional industrial robots that operate in predefined environments such as factories, such mobile robots are expected to operate in public places such as public roads. Robots that can be remotely monitored or remotely controlled by remote operators, fleet management systems that manage the states of many robots, and the like that handle situations where mobile robots have difficulty with autonomous control and achieve efficient mobile robot operations are being investigated and prepared. Utilizing such systems makes it possible to expand the remote work market and provide workplaces for those people who cannot work due to issues such as physical reasons, places of residence, working hours, and the like, which helps solve many issues.

On the other hand, mobile robots have cybersecurity issues. For example, in automobiles, cases of remote intrusion into in-vehicle networks and improper control of automobiles have been reported. There have also been cases of attacks in which ships are guided by transmitting spoofed signals to the Global Positioning System (GPS) of the ship systems.

When an anomaly is detected in such a mobile robot, it is desirable for the mobile robot to move to a safe area, in which safety is ensured and no negative effects will be exerted on the surrounding environment, and to stop.

Patent Literature (PTL) 1 discloses a method in which autonomous travel is performed when a mobile robot detects an anomaly, and the mobile robot moves by autonomous travel to a safe area and stops.

### CITATION LIST

### Patent Literature

PTL 1: Japanese Unexamined Patent Application Publication No. 2020-115397

### SUMMARY

### Technical Problem

When an anomaly is detected in a mobile robot, it is desirable to cause the mobile robot to move to a more appropriate safe area. In the technique in PTL 1, the manner in which the mobile robot is caused to move to a more appropriate safe area can be improved upon.

Accordingly, the present disclosure provides a mobile robot, a server, and a mobile robot control method that, when an anomaly is detected, make it possible to cause a mobile robot to move to a more appropriate safe area.

### Solution to Problem

A mobile robot according to one aspect of the present disclosure is a mobile robot that is capable of autonomous movement, the mobile robot including: a first information obtainer that, when an anomaly in the mobile robot is detected during autonomous movement of the mobile robot, obtains information on a safe area identified based on a state of surroundings of the mobile robot, the safe area being an area at which the mobile robot can stop; and a first controller that, when an anomaly in the mobile robot is detected during autonomous movement of the mobile robot, causes the mobile robot to move to the safe area based on the information on the safe area.

A server according to one aspect of the present disclosure is a server for controlling a mobile robot capable of autonomous movement, the server including: a second information obtainer that, when an anomaly in the mobile robot is detected during autonomous movement of the mobile robot, obtains information on a safe area identified based on a state of surroundings of the mobile robot, the safe area being an area at which the mobile robot can stop; and a second controller that, when an anomaly in the mobile robot is detected during autonomous movement of the mobile robot, causes the mobile robot to move to the safe area based on the information on the safe area.

A mobile robot control system according to one aspect of the present disclosure is a mobile robot control system that includes a mobile robot capable of autonomous movement and a server that communicably connects to the mobile robot, the mobile robot control system including: an information obtainer that, when an anomaly in the mobile robot is detected during autonomous movement of the mobile robot, obtains information on a safe area identified based on a state of surroundings of the mobile robot, the safe area being an area at which the mobile robot can stop; and a controller that, when an anomaly in the mobile robot is detected during autonomous movement of the mobile robot, causes the mobile robot to move to the safe area based on the information on the safe area.

A mobile robot control method according to one aspect of the present disclosure is a mobile robot control method for controlling a mobile robot capable of autonomous movement, the mobile robot control method including: causing the mobile robot to move to a safe area, based on information on the safe area, when an anomaly in the mobile robot is detected during autonomous movement of the mobile robot, the safe area being an area at which the mobile robot can stop and being identified based on a state of surroundings of the mobile robot.

### Advantageous Effects

The one aspect of the present disclosure makes it possible to realize a mobile robot and the like that, when an anomaly has been detected, enable causing the mobile robot to move to a more appropriate safe area.

### BRIEF DESCRIPTION OF DRAWINGS

FIG. 1 illustrates the overall configuration of a mobile robot control system according to an embodiment.

FIG. 2 is a block diagram illustrating the functional configuration of a mobile robot according to an embodiment.

FIG. 3 is a block diagram illustrating the functional configuration of a management server according to an embodiment.

FIG. 4 is a block diagram illustrating the functional configuration of a management server according to an embodiment.

FIG. 5 is a block diagram illustrating the functional configuration of a remote control terminal according to an embodiment.

FIG. 6 is a sequence diagram illustrating the operation of a mobile robot control system in the case of performing autonomous travel, according to an embodiment.

FIG. 7 is a sequence diagram illustrating the operation of a mobile robot control system in the case of performing travel by remote operation, according to an embodiment.

FIG. 8 is a diagram illustrating an example of a first remote operation UI according to an embodiment.

FIG. 9 is a sequence diagram illustrating the operation of a mobile robot control system when detecting an anomaly, according to an embodiment.

FIG. 10 is a first sequence diagram illustrating the operation of a mobile robot control system in the case of a safe area identification failure, according to an embodiment.

FIG. 11 is a diagram illustrating an example of a safe area identification UI according to an embodiment.

FIG. 12 is a second sequence diagram illustrating the operation of a mobile robot control system in the case of a safe area identification failure, according to an embodiment.

FIG. 13 is a diagram illustrating an example of a second remote operation UI according to an embodiment.

FIG. 14 is a first sequence diagram illustrating the operation of a mobile robot control system in the case of autonomous travel function reliability being unsatisfactory, according to an embodiment.

FIG. 15 is a diagram illustrating an example of an emergency stop failure notification UI according to an embodiment.

FIG. 16 is a second sequence diagram illustrating the operation of a mobile robot control system in the case of autonomous travel function reliability being unsatisfactory, according to an embodiment.

FIG. 17 is a flow chart illustrating the operation of a mobile robot according to an embodiment.

### DESCRIPTION OF EMBODIMENTS

### Circumstances Leading to the Present Disclosure

As described in “Background Art”, cybersecurity issues remain for mobile robots. For example, with mobile robots, it is necessary not only to ensure the security of the control network, control applications, control devices, and sensors within the mobile robot, but also to take into account the possibility of the surrounding environment in which the mobile robot actually operates being unreliable, physical access by a malicious third party, and the like. It is also necessary to take into account the security of external devices which access the mobile robot, e.g., servers, terminals operated by client applications, and the like. In this way, there are various security risks for mobile robots. Furthermore, conceivable security risks for mobile robots include not only information theft, service failure risks, and the like in terms of conventional IT (Information Technology), but also cases of affecting, for instance, people, objects, and the environment around the robot.

In the case of a mobile robot receiving a cybersecurity attack or another type of attack, it is necessary not only to ensure the security of the control network, control applications, control devices, sensors, and the like within the mobile robot and of the external devices that access the mobile robot, such as servers and terminals operated by client applications, but also to perform control to guide the mobile robot to a safe state so that the mobile robot itself does not exert negative effects on the surrounding environment. For example, in a case in which a mobile robot senses an anomaly while moving across the middle of a crosswalk, if the mobile robot stops at the current location, the mobile robot will block the road and create an obstacle for the operation of cars, trucks, motorcycles, and the like traveling on the road, whereby there is a risk of causing an accident. In addition, for example, in the case of a mobile robot sensing an anomaly while moving along the hallway within a commercial building, if the mobile robot stops at the current location, the mobile robot will block the hallway and block the movement of people and the flow of goods in the commercial building. In the event that a fire, blaze, or the like was occurring at the same time, there is a risk of the loss of safety for people, objects, and the like.

The mobile robot control system stores, e.g., map information needed for route planning and travel beforehand, but on the other hand, the prior preparation and storage of information on safe areas corresponding to each location to which the mobile robot may travel is support for anomalous situations, and such preparation work and allotting budget and the like accompanying work are difficult. Thus, the prior preparation of information on safe areas is difficult for many mobile robot control systems. Moreover, the surrounding environment involves not only static information such as map information, but also dynamic information not displayed with map information, such as, e.g., situations involving areas that allow passage or stopping being restricted due to construction, states of danger levels changing due to the quantity of human traffic, and the like. Thus, the prior preparation of information on safe areas is difficult. Therefore, measures to, for example, identify information on safe areas from map information and surrounding information when an anomaly is detected are effective.

However, in the method disclosed in PTL 1, the mobile robot is able to move by autonomous travel to a safe area and stop, but no method for identifying a safe area when the mobile robot has detected an anomaly is disclosed. Thus, in the method in PTL 1, the manner in which the mobile robot is caused to move to a more appropriate safe area can be improved upon.

Accordingly, the present inventors thoroughly investigated causing a mobile robot to move to a more appropriate safe area, and invented the mobile robot and the like described hereinafter.

A mobile robot according to a first aspect of the present disclosure is a mobile robot that is capable of autonomous movement, the mobile robot including: a first information obtainer that, when an anomaly in the mobile robot is detected during autonomous movement of the mobile robot, obtains information on a safe area identified based on a state of surroundings of the mobile robot, the safe area being an area at which the mobile robot can stop; and a first controller that, when an anomaly in the mobile robot is detected during autonomous movement of the mobile robot, causes the mobile robot to move to the safe area based on the information on the safe area.

This makes it possible to, when an anomaly is detected, cause the mobile robot to move to a safe area in accordance with a state of the surroundings of the mobile robot at the time of the anomaly being detected (for example, the situations of vehicles, people, and obstacles). Thus, when the anomaly is detected, the mobile robot can move to a more appropriate safe area compared to a case of moving to a safe area set beforehand, i.e., a case of moving to a safe area that does not consider the situation of the surroundings.

Furthermore, for example, a mobile robot according to a second aspect of the present disclosure is the mobile robot according to the first aspect, in which when, during autonomous movement of the mobile robot, the anomaly is detected and the first information obtainer fails to obtain the information on the safe area, the first controller may cause the mobile robot to stop at a current location.

This makes it possible, for example, for the mobile robot to stop at the current location in a case in which there are no safe areas nearby.

Furthermore, for example, a mobile robot according to a third aspect of the present disclosure is the mobile robot according to the second aspect, which may further include: a first user interface (UI) generator that generates a first alert UI when, during autonomous movement of the mobile robot, the anomaly is detected and the first information obtainer fails to obtain the information on the safe area, the first alert UI being for communicating an alert on a server that communicably connects to the mobile robot.

This makes it possible to, by the first alert UI generated by the mobile robot being presented on the server, notify a remote operator of the mobile robot that no safe area has been obtained. When the remote operator who has received the notification makes a response regarding movement of the mobile robot to a safe area, e.g., when the remote operator specifies a safe area, the mobile robot may be able to more certainly move to the safe area.

Furthermore, for example, a mobile robot according to a fourth aspect of the present disclosure is the mobile robot according to the third aspect, in which the first UI generator may generate an obtaining UI used for obtaining the information on the safe area, based on surrounding information that is information on the surroundings of the mobile robot.

This makes it possible for the remote operator of the mobile robot to specify a safe area while confirming the surrounding information of the mobile robot, thereby allowing for setting a more appropriate safe area in accordance with the situation of the surroundings at the time of the anomaly being detected.

Furthermore, for example, a mobile robot according to a fifth aspect of the present disclosure is the mobile robot according to the fourth aspect, in which the surrounding information may include sensor information obtained by a sensor provided to the mobile robot.

This makes it possible for the remote operator of the mobile robot to specify a safe area by using sensor information, thereby allowing for setting a more appropriate safe area in accordance with the situation of the surroundings at the time of the anomaly being detected.

Furthermore, for example, a mobile robot according to a sixth aspect of the present disclosure is the mobile robot according to the fourth or fifth aspect, in which the surrounding information may include video information obtained by a camera provided to the mobile robot.

This makes it possible for the remote operator of the mobile robot to specify a safe area by using video information, thereby allowing for setting a more appropriate safe area in accordance with the situation of the surroundings at the time of the anomaly being detected.

Furthermore, for example, a mobile robot according to a seventh aspect of the present disclosure is the mobile robot according to any one of the fourth to sixth aspects, in which the surrounding information may include current location information that is information on a current location of the mobile robot, the current location information being obtained by a sensor provided to the mobile robot.

This makes it possible for the remote operator of the mobile robot to specify a safe area by using current location information, thereby allowing for setting a more appropriate safe area in accordance with the situation of the surroundings at the time of the anomaly being detected.

Furthermore, for example, a mobile robot according to an eighth aspect of the present disclosure is the mobile robot according to any one of the fourth to seventh aspects, in which the surrounding information may include map information stored beforehand by the server.

This makes it possible for the remote operator of the mobile robot to specify a safe area by using map information, thereby allowing for setting a more appropriate safe area in accordance with the situation of the surroundings at the time of the anomaly being detected.

Furthermore, for example, a mobile robot according to a ninth aspect of the present disclosure is the mobile robot according to any one of the third to eighth aspects, in which the first UI generator may further generate a remote operation UI used for at least one of operating the mobile robot remotely or specifying the information on the safe area, the first controller may cause the mobile robot to move based on information inputted into the remote operation UI on the server, and the first information obtainer may obtain the information on the safe area, the information on the safe area being based on the information inputted into the remote operation UI.

Presenting, on the server, a remote operation UI generated by the mobile robot makes it possible to allow the remote operator of the mobile robot to perform remote operation. In other words, even in a case of failing to obtain information on a safe area, the mobile robot can move to a safe area by means of the remote operator. Thus, even in the case of failing to obtain information on a safe area, the mobile robot can move to a more appropriate safe area.

Furthermore, a server according to a tenth aspect of the present disclosure is a server for controlling a mobile robot capable of autonomous movement, the server including: a second information obtainer that, when an anomaly in the mobile robot is detected during autonomous movement of the mobile robot, obtains information on a safe area identified based on a state of surroundings of the mobile robot, the safe area being an area at which the mobile robot can stop; and a second controller that, when an anomaly in the mobile robot is detected during autonomous movement of the mobile robot, causes the mobile robot to move to the safe area based on the information on the safe area.

This makes it possible to, when an anomaly is detected, cause the mobile robot to move to a safe area in accordance with a state of the surroundings of the mobile robot at the time of the anomaly being detected (for example, the situation of vehicles, people, and obstacles). Thus, when the anomaly is detected, the server can cause the mobile robot to move to a more appropriate safe area compared to a case of moving to a safe area set beforehand, i.e., a case of moving to a safe area that does not consider the situation of the surroundings.

Furthermore, for example, a server according to an eleventh aspect of the present disclosure is the server according to the tenth aspect, in which when, during autonomous movement of the mobile robot, the anomaly is detected and the second information obtainer fails to obtain the information on the safe area, the second controller may cause the mobile robot to stop at a current location.

This makes it possible, for example, to cause the mobile robot to stop at the current location in a case in which there are no safe areas nearby.

Furthermore, for example, a server according to a twelfth aspect of the present disclosure is the server according to the tenth or eleventh aspect, which may further include: a second user interface (UI) generator that generates a second alert UI when, during autonomous movement of the mobile robot, the anomaly is detected and the second information obtainer fails to obtain the information on the safe area, the second alert UI being for communicating an alert.

This makes it possible to notify the remote operator of the mobile robot that no safe area has been obtained, by the second alert UI being presented on the server. When the remote operator who has received the notification makes a response regarding movement of the mobile robot to a safe area, e.g., when the remote operator specifies a safe area, the server may be able to cause the mobile robot to more certainly move to a safe area.

Furthermore, for example, a server according to a thirteenth aspect of the present disclosure is the server according to any one of the tenth to twelfth aspects, in which the second UI generator may generate an obtaining UI used for obtaining the information on the safe area, based on surrounding information that is information on the surroundings of the mobile robot.

This makes it possible for the remote operator of the mobile robot to specify a safe area while confirming the surrounding information of the mobile robot, thereby allowing for setting a more appropriate safe area in accordance with the situation of the surroundings at the time of the anomaly being detected.

Furthermore, for example, a server according to a fourteenth aspect of the present disclosure is the server according to the thirteenth aspect, in which the surrounding information may include sensor information obtained by a sensor provided to the mobile robot.

This makes it possible for the remote operator of the mobile robot to specify a safe area using sensor information, thereby allowing for setting a more appropriate safe area in accordance with the situation of the surroundings at the time of the anomaly being detected.

Furthermore, for example, a server according to a fifteenth aspect of the present disclosure is the server according to the fourteenth aspect, in which the surrounding information may include video information obtained by a camera provided to the mobile robot.

This makes it possible for the remote operator of the mobile robot to specify a safe area by using video information, thereby allowing for setting a more appropriate safe area in accordance with the situation of the surroundings at the time of the anomaly being detected.

Furthermore, for example, a server according to a sixteenth aspect of the present disclosure is the server according to any one of the tenth to fifteenth aspects, in which the surrounding information may include current location information that is information on a current location of the mobile robot, the current location information being obtained by a sensor provided to the mobile robot.

This makes it possible for the remote operator of the mobile robot to specify a safe area by using current location information, thereby allowing for setting a more appropriate safe area in accordance with the situation of the surroundings at the time of the anomaly being detected.

Furthermore, for example, a server according to a seventeenth aspect of the present disclosure is the server according to any one of the tenth to sixteenth aspects, in which the surrounding information may include map information stored beforehand by the server.

This makes it possible for the remote operator of the mobile robot to specify a safe area by using map information, thereby allowing for setting a more appropriate safe area in accordance with the situation of the surroundings at the time of the anomaly being detected.

Furthermore, for example, a server according to an eighteenth aspect of the present disclosure is the server according to any one of the tenth to seventeenth aspects, in which the second UI generator may further generate a remote operation UI used for at least one of operating the mobile robot remotely or specifying the information on the safe area, the second controller may move the mobile robot based on information inputted into the remote operation UI on the server, and the second information obtainer may obtain the information on the safe area, the information on the safe area being based on the information inputted into the remote operation UI.

This makes it possible to present the remote operation UI to allow the remote operator of the mobile robot to perform remote operation. In other words, even in a case of failing to obtain information on a safe area, the server can cause the mobile robot to be moved to a safe area by the remote operator. Thus, even in the case of failing to obtain information on a safe area, the server can cause the mobile robot to move to a more appropriate safe area.

Furthermore, a mobile robot control system according to a nineteenth aspect of the present disclosure is a mobile robot control system that includes a mobile robot capable of autonomous movement and a server that communicably connects to the mobile robot, the mobile robot control system including: an information obtainer that, when an anomaly in the mobile robot is detected during autonomous movement of the mobile robot, obtains information on a safe area identified based on a state of surroundings of the mobile robot, the safe area being an area at which the mobile robot can stop; and a controller that, when an anomaly in the mobile robot is detected during autonomous movement of the mobile robot, causes the mobile robot to move to the safe area based on the information on the safe area. Furthermore, a mobile robot control method according to a twentieth aspect of the present disclosure is a mobile robot control method for controlling a mobile robot capable of autonomous movement, the mobile robot control method including: causing the mobile robot to move to a safe area, based on information on the safe area, when an anomaly in the mobile robot is detected during autonomous movement of the mobile robot, the safe area being an area at which the mobile robot can stop and being identified based on a state of surroundings of the mobile robot.

Accordingly, the same effects as those of the mobile robot or the server are achieved.

Note that these comprehensive or specific aspects may be realized by a system, a method, an integrated circuit, a computer program, or a non-transitory computer-readable recording medium such as a CD-ROM, or may be implemented by any desired combination of systems, devices, methods, integrated circuits, computer programs, or recording media. The program may be stored in advance in a recording medium, or may be supplied to the recording medium via a wide-area communication network including the Internet.

A mobile robot control system and a mobile robot control method according to an embodiment of the present disclosure will be described hereinafter with reference to the drawings. Note that the following embodiments describe preferred specific examples of the present disclosure. The numerical values, shapes, materials, constituent elements, arrangements and connection states of constituent elements, steps, orders of steps, and the like in the following embodiments are merely examples of the present disclosure, and are not intended to limit the present disclosure. The present disclosure is specified based on the content of the scope of claims. Accordingly, of the constituent elements in the following embodiments, constituent elements not denoted in the independent claims, which indicate the broadest interpretation of the present disclosure, are not absolutely necessary for solving the problem of the present disclosure, and will instead be described as constituent elements constituting more preferred forms.

Additionally, the drawings are schematic diagrams, and are not necessarily exact illustrations. As such, the scales and so on, for example, are not necessarily consistent from drawing to drawing. Furthermore, configurations that are substantially the same are given the same reference signs in the drawings, and redundant descriptions will be omitted or simplified.

Additionally, in the present specification, numerical values and numerical value ranges do not express the items in question in the strictest sense, and also include substantially equivalent ranges, e.g., differences of approximately several percent (e.g., approximately 10%), as well.

Furthermore, in the present specification, unless otherwise specified particularly, ordinals such as “first” and “second” do not have the meaning of the number or order of elements, and are used to avoid confusion regarding and to distinguish between elements of the same type.

### Embodiment

A mobile robot control method that includes a method by which a mobile robot identifies a safe area and a method by which a mobile robot moves to a safe area when the system is in an unreliable state, and the like will be described hereinafter. Moreover, for example, a mobile robot and the like for causing a mobile robot to stop at a safe location when a security anomaly is detected by a mobile robot control system will be described hereinafter.

### 1 Overall Configuration of Mobile Robot Control System

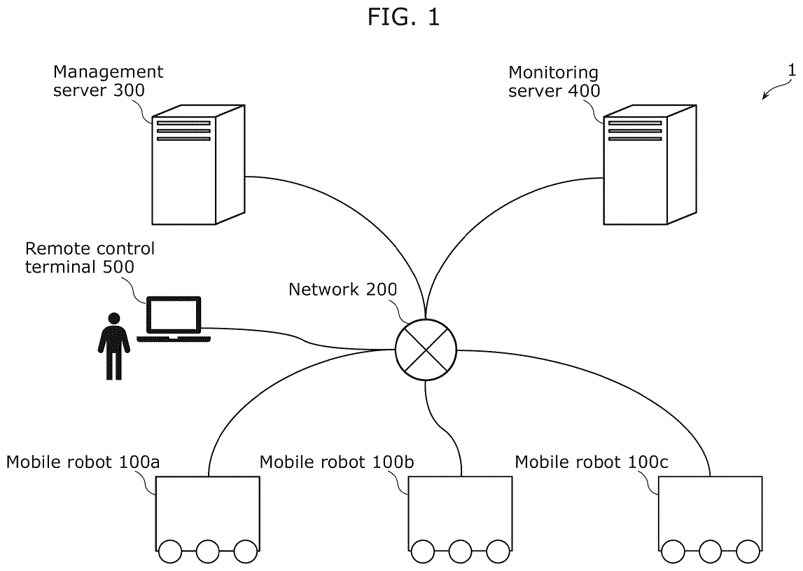

FIG. 1 illustrates the overall configuration of mobile robot control system 1 according to an embodiment.

As illustrated in FIG. 1, mobile robot control system 1 is an information processing system for monitoring mobile robots 100a, 100b, and 100c, and includes mobile robot 100a, mobile robot 100b, mobile robot 100c, network 200, management server 300, monitoring server 400, and remote control terminal 500. Mobile robots 100a, 100b, and 100c all have the same configuration, and therefore may be collectively described as mobile robot 100 hereinafter. Management server 300, monitoring server 400, and remote control terminal 500 are outside of mobile robot 100, and are disposed remotely from mobile robot 100.

Mobile robot 100 is a mobile body capable of autonomous movement and is a robot or vehicle capable of autonomous travel or a flying body (for example, a drone) capable of autonomous flight, but is not limited thereto. Mobile robot 100 may be capable of performing predetermined services. The predetermined services are, for example, delivery services, collection services, passenger transportation services, and/or the like, but are not limited thereto. Furthermore, mobile robot 100 may be capable of traveling on roads, and may be capable of traveling on sidewalks.

Mobile robot 100 communicates robot states such as control states, location information, security alerts, and the like of mobile robot 100 to management server 300 and monitoring server 400 over network 200. Note that the total number of mobile robots 100 included in mobile robot control system 1 is not limited to 3, and is only required to be 1 or more. Moreover, mobile robot 100 included in mobile robot control system 1 may encompass mobile bodies of a plurality of types (for example, robots, vehicles, flying bodies, and the like).

Network 200 can include the Internet or a dedicated line. Network 200 communicably connects to each of mobile robot 100, management server 300, monitoring server 400, and remote control terminal 500. Note that the communication method between mobile robot 100, management server 300, monitoring server 400, and remote control terminal 500 is not particularly limited, and may be wireless communication or may be wired communication. A combination of wireless communication and wired communication may also be used between the apparatuses.

Management server 300 receives the robot states of mobile robot 100 from mobile robot 100, and provides, to the remote operator of mobile robot 100, an interface for managing whether mobile robot 100 is operating properly. Moreover, when mobile robot 100 requires remote operation, management server 300 generates a remote operation UI (“UI” is an abbreviation of “user interface”) used for remote operation, and transmits the remote operation UI to remote control terminal 500 over network 200. The remote operator corresponds to the remote operator described above, and the remote operator remotely monitors mobile robot 100, and performs remote operation (remote handling) as needed.

Monitoring server 400 is a server that primarily monitors whether a security incident has occurred in mobile robot 100, and receives security alerts from mobile robot 100 and provides, to a security operations center or a security incident response team, an interface for analysis and response. Monitoring server 400 may, for example, provide the interface for analysis or response to remote control terminal 500.

Remote control terminal 500 presents the remote operation UI received to a monitor or the like, receives the instruction of the remote operator from the remote operation UI, and sends the remote operation instruction to mobile robot 100 over network 200 and management server 300 to make it possible to remotely operate mobile robot 100. Note that remote control terminal 500 may transmit the remote operation instruction directly to mobile robot 100 without the use of management server 300.

### 2 Configuration of Mobile Robot 100

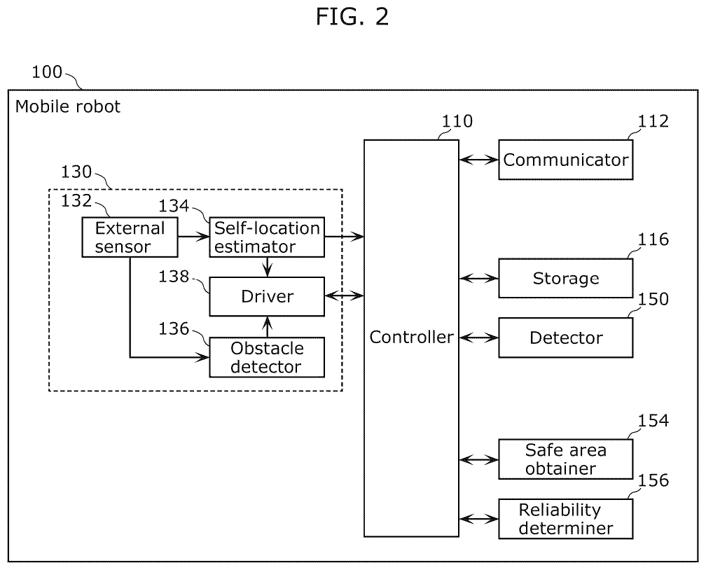

FIG. 2 is a block diagram illustrating the functional configuration of mobile robot 100 according to the embodiment.

As illustrated in FIG. 2, mobile robot 100 includes controller 110, communicator 112, storage 116, external sensor 132, self-location estimator 134, driver 138, obstacle detector 136, detector 150, safe area obtainer 154, and reliability determiner 156. Note that a component that includes external sensor 132, self-location estimator 134, obstacle detector 136, and driver 138 is also described as autonomous travel function 130 (an autonomous travel function component) for enabling mobile robot 100 to autonomously travel. Autonomous travel function 130 is an example of an autonomous travel function. Mobile robot 100 has a CPU (Central Processing Unit), memory, and the like, and a program stored in the memory is executed by the CPU to realize the functions of mobile robot 100.

Controller 110 is a control device that controls the elements of mobile robot 100. Specifically, controller 110 relays communication between and controls autonomous travel function 130, communicator 112, storage 116, detector 150, and safe area obtainer 154. Moreover, during autonomous travel of mobile robot 100, when an anomaly is detected in mobile robot 100 or when an anomaly is detected in mobile robot 100 and reliability determiner 156 has determined that autonomous travel function 130 is reliable, controller 110 may control driver 138 to cause mobile robot 100 to move to a safe area, based on information on the safe area. Furthermore, during autonomous travel of mobile robot 100, when an anomaly is detected in mobile robot 100 and safe area obtainer 154 fails to obtain information on a safe area or when an anomaly is detected in mobile robot 100 and reliability determiner 156 has determined that autonomous travel function 130 is unreliable, controller 110 may control driver 138 to cause mobile robot 100 to stop at the current location. Controller 110 is an example of a first controller.

Communicator 112 mainly communicates with management server 300 and monitoring server 400. Communicator 112 performs data communication with management server 300 and monitoring server 400 over network 200. Communicator 112 is configured including communication circuitry (a communication module).

Storage 116 stores destination information indicating a destination of mobile robot 100, map information in a range that includes the destination of mobile robot 100, and the like. Storage 116 is, for example, achieved by semiconductor memory, but is not limited thereto. Controller 116 is an example of a first storage.

External sensor 132 obtains surrounding information that includes a state of the surroundings of mobile robot 100. External sensor 132 is, for example, a camera (for example, a visible light camera), a laser rangefinder, a GPS sensor, or the like. Note that the visible light camera obtains videos of the surroundings of mobile robot 100. The laser rangefinder obtains, for example, point cloud information on the surroundings of mobile robot 100. The GPS sensor obtains location information including the current latitude, longitude, and altitude of mobile robot 100. Moreover, the videos of the surroundings from the visible light camera, the point cloud information of the laser rangefinder, and the like may be analyzed using AI or the like to, e.g., obtain object information on objects such as people, motorcycles, and bicycles present in the surroundings of mobile robot 100, generate a structure of the surroundings as three-dimensional information, and the like, and add these to the surrounding information.

In this way, the surrounding information may include sensor information obtained by a sensor provided to mobile robot 100 or current location information of mobile robot 100, and may include video information obtained by a camera provided to mobile robot 100. In addition, the surrounding information may include map information that has been stored beforehand by management server 300. The surrounding information may also include, e.g., objects in the surroundings of mobile robot 100, the state of the road on which mobile robot 100 moves, and the like.

Self-location estimator 134 analyzes, e.g., the location information among the external information obtained by external sensor 132 to estimate the current location of mobile robot 100. The current location may be a relative location, or may be an absolute location.

Obstacle detector 136 analyzes external information (for example, object information) obtained by external sensor 132 to specify/detect obstacles that will obstruct travel. Obstacle detector 136 may, for example, identify objects present in a travel path of the autonomous travel as obstacles.

Driver 138 analyzes the current location estimated by self-location estimator 134 and the obstacles identified by obstacle detector 136 and actually operates the propulsion function of wheels, propellers, and the like to cause mobile robot 100 to move. At this time, driver 138 moves mobile robot 100 along the path for moving to the destination, but when it is determined that an obstacle is present in the path, driver 138 performs driving such that mobile robot 100 avoids the obstacles, and controls mobile robot 100 to be able to ultimately arrive at the destination. In actual driving, electric power such as a motor and a storage battery, engine power such as an engine and a fuel tank, and the like are needed in addition to the propulsion function of tires, propellers, etc. and a steering system. However, these do not fall under the essence of the present disclosure, and detailed explanation of driving has thus been omitted.

Detector 150 monitors the entire interior of mobile robot 100 to determine that there are no cyberattacks on mobile robot 100, and when a cyberattack is detected, the cyberattack is transmitted as attack information to monitoring server 400 over network 200. It can also be stated that detector 150 determines whether there is a cyberattack on mobile robot 100, and when detector 150 determines that there is a cyberattack, the cyberattack is transmitted as attack information to monitoring server 400 over network 200. The attack information includes, for example, that there is a cyberattack, information that indicates whether the cyberattack was detected inside or outside of autonomous travel function 130, and the like. Controller 150 is an example of an anomaly detector. Note that as a method for using detector 150 to determine whether there is a cyberattack, any known technique may be used.

Safe area obtainer 154 obtains information on the safe area that is closest to the current location. For example, when detector 150 has detected an anomaly in mobile robot 100 while mobile robot 100 is performing autonomous travel, safe area obtainer 154 obtains information on a safe area at which mobile robot 100 can stop (can make, for example, an emergency stop), the safe area being identified based on the state of the surroundings of mobile robot 100. The state of the surroundings of mobile robot 100 is acceptable as long as it is information that enables obtaining information on the safe area, and may be the state of the surroundings of mobile robot 100 when the anomaly was detected, or may be the state of the surroundings of mobile robot 100 when no anomaly has been detected (for example, before an anomaly is detected). The safe area may be an area at which mobile robot 100 does not exert negative effects on the surrounding environment and at which the safety of mobile robot 100 is ensured, or may be an area at which mobile robot 100 can safely stop (can make, for example, an emergency stop). Safe area obtainer 154 is an example of a first information obtainer.

Reliability determiner 156 determines whether mobile robot 100 and autonomous travel function 130 are in a reliable state in terms of movement (for example, travel), based on the attack information obtained by detector 150 or the destination information stored in storage 116. Reliability determiner 156 determines, for example, the reliability of autonomous travel function 130 of mobile robot 100. When the existence of a cyberattack in autonomous travel function 130 is included in the attack information, reliability determiner 156 determines that autonomous travel function 130 is unreliable in terms of travel, and when the existence of a cyberattack in a function other than autonomous travel function 130 (in another function component) is included in the attack information, reliability determiner 156 determines that autonomous travel function 130 is reliable in terms of travel. In this way, when an attack relating to autonomous travel function 130 has been detected, reliability determiner 156 may determine that autonomous travel function 130 is unreliable.

Furthermore, reliability determiner 156 may, in accordance with whether tampering of the destination information has been detected, determine whether autonomous travel function 130 is reliable. When tampering of the destination indicated by the destination information is detected, reliability determiner 156 may determine that autonomous travel function 130 is unreliable, and when tampering of the destination has not been detected, reliability determiner 156 may determine that autonomous travel function 130 is reliable. Reliability determiner 156 is an example of a first determiner.

### 3 Configuration of Management Server 300

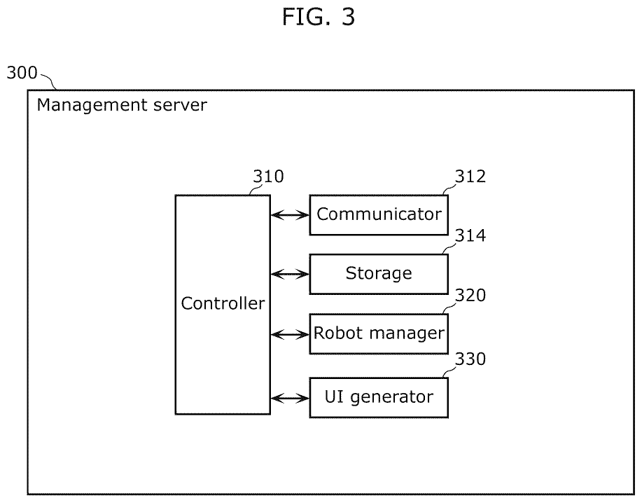

FIG. 3 is a block diagram illustrating the functional configuration of management server 300 according to the embodiment.

As illustrated in FIG. 3, management server 300 includes controller 310, communicator 312, storage 314, robot manager 320, and UI generator 330. Management server 300 has a CPU, memory, and the like, and a program stored in the memory is executed by the CPU to realize the functions of management server 300.

Controller 310 is a control device that controls the elements of management server 300. Specifically, controller 310 controls communicator 312, storage 314, robot manager 320, and UI generator 330.

Communicator 312 mainly communicates with mobile robot 100 and remote control terminal 500. For example, communicator 312 transmits, over network 200, robot management information of robot manager 320 to mobile robot 100, and various UIs generated by UI generator 330 to remote control terminal 500. Communicator 312 is configured including communication circuitry (a communication module).

Storage 314 stores various UIs generated by UI generator 330. Storage 314 is, for example, achieved by semiconductor memory, but is not limited thereto.

Robot manager 320 manages control information for mobile robot 100. The control information includes, for example, commands for operating mobile robot 100.

UI generator 330 generates various UIs. For example, during autonomous travel of mobile robot 100, when an anomaly is detected and safe area obtainer 154 fails to obtain information on a safe area or reliability determiner 156 determines that autonomous travel function 130 is unreliable, UI generator 330 may generate an alert UI (an example of the third alert UI) for communicating an alert on a server (for example, management server 300) communicably connected to mobile robot 100. The UI generated by UI generator 330 is described later. UI generator 330 is an example of a third UI generator.

### 4 Configuration of Monitoring Server 400

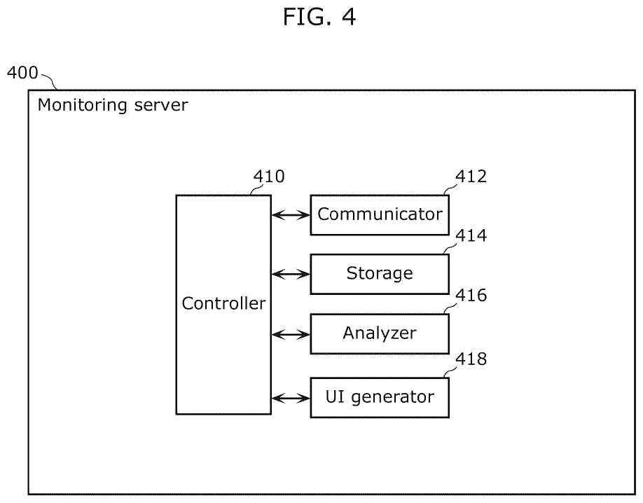

FIG. 4 is a block diagram illustrating the functional configuration of monitoring server 400 according to the embodiment.

As illustrated in FIG. 4, monitoring server 400 includes controller 410, communicator 412, storage 414, analyzer 416, and UI generator 418. Monitoring server 400 has a CPU, memory, and the like, and a program stored in the memory is executed by the CPU to realize the functions of monitoring server 400.

Controller 410 is a control device that controls the elements of monitoring server 400. Specifically, controller 410 controls communicator 412, storage 414, analyzer 416, and UI generator 418.

Communicator 412 mainly communicates with remote control terminal 500. For example, communicator 412 transmits various UIs generated by UI generator 418 to remote control terminal 500 over network 200. Communicator 412 is configured including communication circuitry (a communication module).

Storage 414 stores various UIs generated by UI generator 418, and log information of mobile robot 100 received by communicator 412. The log information includes robot states such as control states, location information, security alerts, and the like of mobile robot 100. Storage 314 is, for example, achieved by semiconductor memory, but is not limited thereto.

Analyzer 416 analyzes the log information of mobile robot 100 that is stored by storage 414 to detect an anomaly in mobile robot 100. Analyzer 416 analyzes the log information from each of mobile robots 100a to 100c to detect an anomaly in each of mobile robots 100a to 100c.

UI generator 418 generates various UIs.

### 5 Configuration of Remote Control Terminal 500

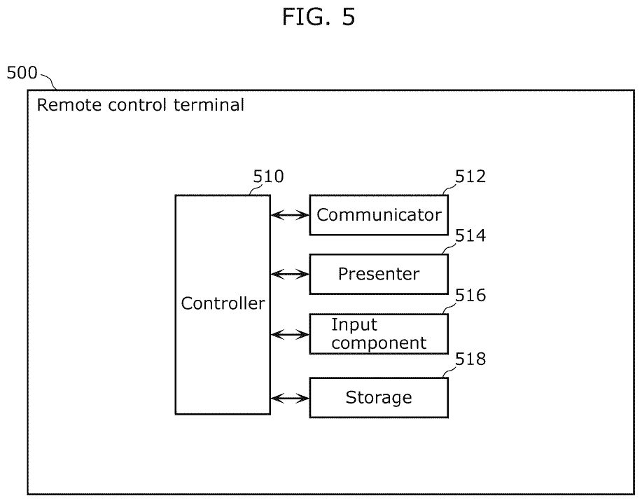

FIG. 5 is a block diagram illustrating the functional configuration of remote control terminal 500 according to the embodiment. Remote control terminal 500 may be a stationary device such as a PC (personal computer) or the like, or may be a portable device such as a smartphone or the like.

As illustrated in FIG. 5, remote control terminal 500 has controller 510, communicator 512, presenter 514, input component 516, and storage 518. Remote control terminal 500 has a CPU, memory, and the like, and a program stored in the memory is executed by the CPU to realize the functions of remote control terminal 500.

Controller 510 is a control device that controls the elements of remote control terminal 500. Specifically, controller 510 controls communicator 512, presenter 514, input component 516, and storage 518.

Communicator 512 is configured including communication circuitry (a communication module) for communicating mainly with management server 300 and monitoring server 400.

Presenter 514 presents various UIs received from management server 300 or monitoring server 400. Presenter 514 is, for example, configured including a display panel such as a liquid crystal panel or the like.

Input component 516 accepts inputs (operations) from the remote operator. For example, input component 516 accepts inputs that correspond to UIs that were presented by presenter 514. Input component 516 may be achieved by a joystick, a touch panel that accepts touch operations, a sound collection device that accepts inputs by voice, an imaging device that accepts inputs by means of gestures or the like, or the like.

Storage 518 stores various UIs and the like that are received from management server 300 or monitoring server 400. Storage 518 is, for example, achieved by semiconductor memory, but is not limited thereto.

### 6 Autonomous Travel Sequence

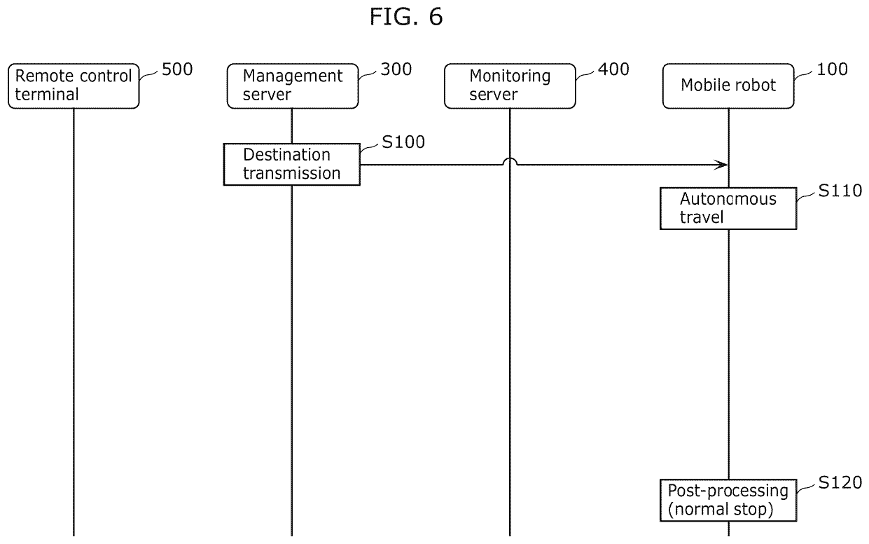

FIG. 6 is a sequence diagram illustrating the operation of mobile robot control system 1 (the mobile robot control method) in the case of performing autonomous travel, according to the embodiment. Specifically, FIG. 6 is an autonomous travel sequence diagram that describes the situation of mobile robot 100 autonomously traveling to a destination.

(S100) Management server 300 transmits destination information (a destination) stored by storage 314 to mobile robot 100 via communicator 312.

(S110) Mobile robot 100 receives the destination information from management server 300 via communicator 112, and causes mobile robot 100 to move based on the destination received by driver 138 and the self-location estimated by self-location estimator 134.

(S120) When mobile robot 100 arrives at the destination, mobile robot 100 stops (normal stop), and notifies management server 300 of arrival completion. Moreover, mobile robot 100 performs post-processing in accordance with the service. For example, in a case in which the service is a delivery service that involves delivering bread from a bakery to the home of an end user, the end user is notified of the arrival of mobile robot 100, and when the end user leaves his/her home and approaches mobile robot 100, the end user is further notified of the unlocking code for the loading component of mobile robot 100. Then, when the end user inputs the unlocking code into the unlocking code input component of the loading component, opens the door of the loading component, removes the bread that is the delivery article, and closes the door of the loading component, mobile robot 100 transmits a thank-you message to the end user, transmits a delivery article receipt completion message to management server 300, and begins movement to the mobile robot 100 base. When mobile robot 100 further arrives at the mobile robot 100 base, the series of delivery services are concluded.

### 7 Sequence of Travel by Remote Operation

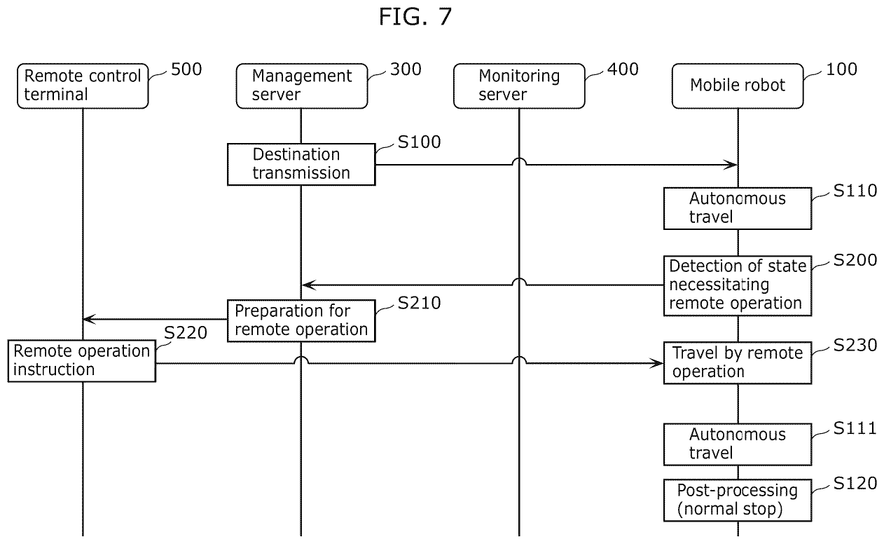

FIG. 7 is a sequence diagram illustrating the operation of mobile robot control system 1 (the mobile robot control method) in the case of performing travel by remote operation, according to the embodiment. Using FIG. 7, a case of mobile robot 100 switching, while moving by autonomous travel to the destination, from autonomous travel to travel by remote operation will be explained. For example, in a case in which a crosswalk is included in a route for which travel to a destination is planned, when mobile robot 100 arrives in front of the crosswalk by autonomous travel, it is conceivable to seek a remote operator's determination when crossing the crosswalk. In this case, the crossing determination performed by the remote operator is performed based on, e.g., checking whether the signal is green, whether crossing is possible, whether an obstacle is present in the crosswalk, and the like, as well as checking the states of vehicles, motorcycles, and the like that are traveling on the road and approaching the crosswalk area.

Note that management server 300 or obstacle detector 136 of mobile robot 100 may also analyze videos of the surroundings of mobile robot 100 to automatically perform the crossing determination. On the other hand, depending on the sensor performance and resolution, seeking the remote operator's determination is conceivable. When the crossing determination is performed and it is possible to cross, autonomous travel may be restored and mobile robot 100 may autonomously move across the crosswalk, or mobile robot 100 may move across the crosswalk while still traveling by remote operation. Note that there may be cases in which crossing determination by a remote operator and movement by remote operation are required due to laws and regulations.

Hereinafter, the sequence of travel by remote operation will be described. Note that hereinafter, the same reference signs as in FIG. 6 have been appended to operations that are the same as the operations indicated in FIG. 6, and description thereof has been omitted or simplified.

(S100) This has been omitted since it was described in the above text.

(S110) This has been omitted since it was described in the above text.

(S200) When, during autonomous travel of mobile robot 100, mobile robot 100 enters a state that requires remote operation, controller 110 of mobile robot 100 detects that the state necessitates remote operation. Controller 110 determines whether determination and travel by remote operation are necessary based on, for example, the current location, the surrounding information obtained by external sensor 132, and the self-location estimated by self-location estimator 134. When controller 110 determines that remote operation is necessary, mobile robot 100 stops autonomous travel and stops at the current location, or reduces in movement speed (slows down). Further, controller 110 issues a request to management server 300 for remote operation. Note that mobile robot 100 has determined the necessity of remote operation, but there may be a configuration in which management server 300 makes the determination.

(S210) When robot manager 320 of management server 300 receives a request for remote operation from mobile robot 100 via communicator 312, UI generator 330 generates a first remote operation UI. For example, the first remote operation UI may be a UI that presents videos of the surroundings of a crosswalk, the UI having provided thereon a button for confirming the determination of whether crossing the crosswalk is possible. Generating the first remote operation UI is an example of preparation for remote operation.

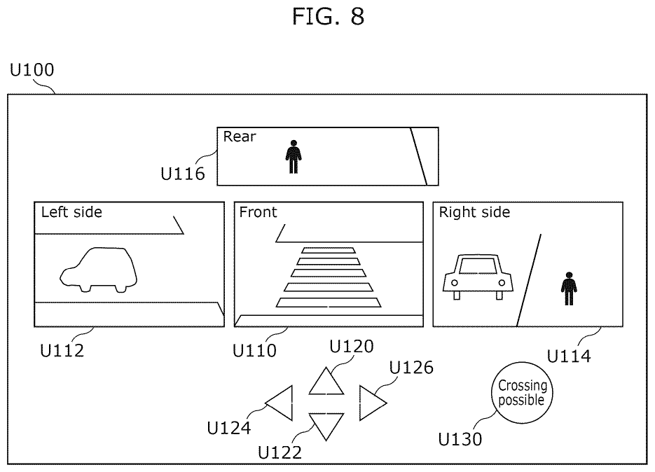

FIG. 8 is a diagram illustrating an example of a first remote operation UI according to the embodiment. U100 is the overall UI area presented on the monitor. First display area U110 is an area that displays a front-side video with respect to mobile robot 100. By receiving a video from, e.g., a visible light camera with external sensor 132 of mobile robot 100 and displaying the video on first display area U110, the remote operator can confirm the state of the surroundings of mobile robot 100. Second display area U112 is an area that displays a left-side video with respect to mobile robot 100. Third display area U114 is an area that displays a right-side video with respect to mobile robot 100. Fourth display area U116 is an area that displays a rear-side video with respect to mobile robot 100. Second display area U112, third display area U114, and fourth display area U116 are, similarly to first display area U110, achieved by, for example, linkage with external sensor 132 of mobile robot 100. Note that front means, for example, an advancing direction of mobile robot 100 and rear means, for example, a direction opposite the advancing direction of mobile robot 100.

Furthermore, first button U120 is a button that instructs mobile robot 100 to move forward. Similarly, second button U122, third button U124, and fourth button U126 are buttons that give instructions to move to the rear, left, or right, respectively. The remote operator can perform remote operation of mobile robot 100 by pressing these buttons. Note that the instruction buttons for remote operation have been placed on the screen of overall UI area U100 that includes the display areas, but instructions for remote operation may be performed not on the screen of overall UI area U100, but using a different device that is connected to remote control terminal 500. For example, a video game controller, a flight simulator operation device, or the like can be used as the device for remote operation.

Furthermore, fifth button U130 is a button for specifying that crossing is possible. When mobile robot 100 is stopped in front of a crosswalk, the remote operator checks first display area U110, second display area U112, third display area U114, and fourth display area U116, which display the front-side, rear-side, left-side, and right-side videos with respect to mobile robot 100, verifies that there is no danger regarding, for example, the states of vehicles, motorcycles, and the like approaching from the distance, and then, when it has been determined that there are no safety issues, presses fifth button U130. This makes it possible to move mobile robot 100. In this case, movement by remote operation may be continued as-is, or the remote operation may be ended and autonomous travel may be switched to for the movement of mobile robot 100.

Once again referring to FIG. 7, the description will be continued.

(S220) When the first remote operation UI is received from management server 300, remote control terminal 500 presents the first remote operation UI to presenter 514 (for example, a monitor), and seeks the remote operator's determination. When the remote operator uses the first remote operation UI to input that it is possible to cross the crosswalk (for example, the remote operator operates fifth button U130), remote control terminal 500 transmits the remote operation instruction, which is in this case a notification that it is possible to cross the crosswalk, to mobile robot 100.

(S230) When mobile robot 100 receives, via management server 300, an instruction for remote operation from remote control terminal 500, in this case being a notification that it is possible to cross, mobile robot 100 begins travel by remote operation.

(S111) When the travel across the crosswalk ends, mobile robot 100 switches to autonomous travel and restarts movement by autonomous travel.

(S120) This has been omitted since it was described in the above text.

### 8 Sequence When Anomaly is Detected

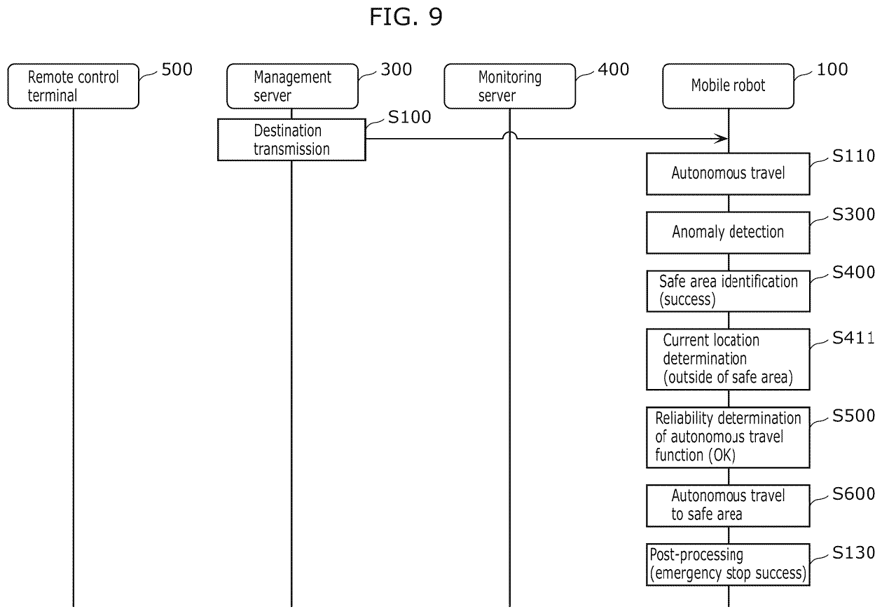

FIG. 9 is a sequence diagram illustrating the operation of mobile robot control system 1 (the mobile robot control method) when an anomaly is detected, according to the embodiment. A sequence in which mobile robot 100 detects an anomaly while moving by autonomous travel to a destination, identifies a safe area, determines the reliability of the autonomous travel function, and moves to the safe area by autonomous travel is described with reference to FIG. 9.

(S100) This has been omitted since it was described in the above text.

(S110) This has been omitted since it was described in the above text.

(S300) When detector 150 of mobile robot 100 recognizes that, during autonomous travel, there has been unauthorized access to the system of mobile robot 100, e.g., there has been an unauthorized login into an account, mobile robot 100, for example, stops autonomous travel and stops at the current location or slows down. Further, detector 150 makes a notification to safe area obtainer 154, as an anomaly state. Note that recognizes means that an occurrence has become clear, and means, for example, detecting. For example, recognizing unauthorized access means that an occurrence of unauthorized access has become clear, and means, for example, detecting unauthorized access using detector 150.

(S400) Safe area obtainer 154 attempts to obtain information on a safe area, based on the surrounding information obtained by external sensor 132. When information on a safe area was able to be obtained, a notification is made to reliability determiner 156.

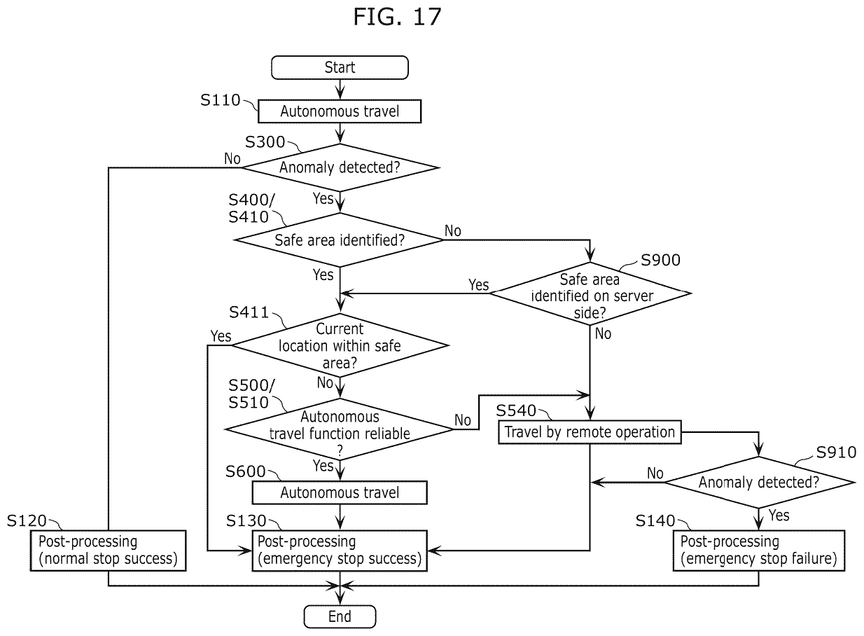

(S411) Reliability determiner 156 determines whether the current location of mobile robot 100 that was estimated by self-location estimator 134 is within the safe area. When it is determined that the current location is within the safe area, step S130 is proceeded to (for example, see FIG. 17, described later). When it is determined that the current location is outside of the safe area, step S500 is proceeded to.

(S500) Reliability determiner 156 determines, from autonomous travel function 130 and the anomaly state, whether autonomous travel function 130 is reliable in terms of performing autonomous travel. When it is determined that autonomous travel function 130 is reliable, controller 110 gives an instruction to driver 138 for autonomous travel to the safe area.

(S600) Driver 138 causes mobile robot 100 to move to the safe area by autonomous travel.

(S130) When mobile robot 100 moves to the safe area, post-processing is performed, such as notifying management server 300 that an emergency stop was able to be made at the safe area.

### 9 First Sequence for Safe Area Identification Failure

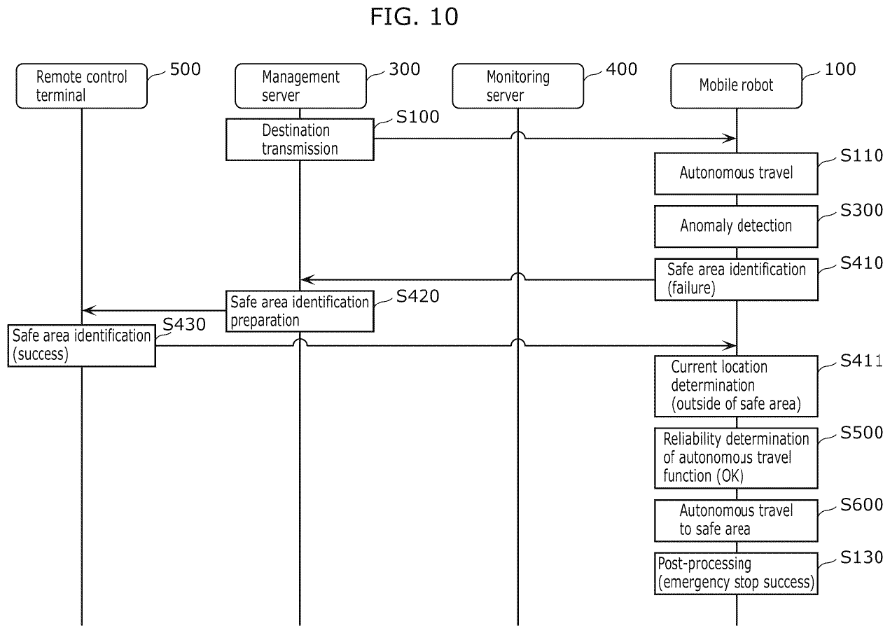

FIG. 10 is a first sequence diagram illustrating the operation of mobile robot control system 1 (the mobile robot control method) in the case of safe area identification failure, according to the embodiment. A sequence in which mobile robot 100 detects an anomaly while moving by autonomous travel to a destination and fails to identify a safe area, whereby management server 300 or remote control terminal 500 identifies a safe area, and then the reliability of autonomous travel function 130 of mobile robot 100 is determined and mobile robot 100 moves by autonomous travel to the safe area is described with reference to FIG. 10. Note that hereinafter, the same reference signs as in FIG. 9 have been appended to operations that are the same as the operations indicated in FIG. 9, and description thereof has been omitted or simplified.

(S100) This has been omitted since it was described in the above text.

(S110) This has been omitted since it was described in the above text.

(S300) This has been omitted since it was described in the above text.

(S410) Safe area obtainer 154 attempts to obtain information on a safe area, based on the surrounding information obtained by external sensor 132. In a case of failure to obtain information on a safe area, a notification of failure to obtain information on a safe area is made to management server 300.

(S420) UI generator 330 of management server 300 receives, via communicator 312, the failure to obtain information on a safe area, generates a safe area identification UI used for obtaining (identifying) a safe area, and transmits the safe area identification UI to remote control terminal 500.

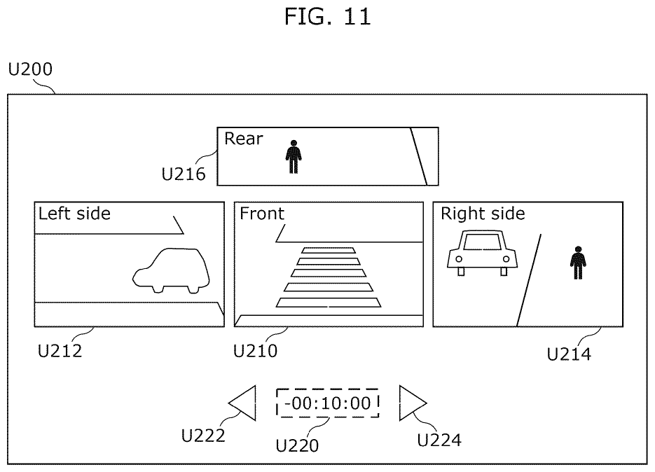

FIG. 11 is a diagram illustrating an example of a safe area identification UI according to the embodiment. The safe area identification UI illustrated in FIG. 11 is an example of the remote operation UI used for specifying information on a safe area.

U200 is the overall UI area presented on the monitor. Fifth display area U210 is an area that displays a front-side video with respect to mobile robot 100. A video from, e.g., a visible light camera is received with external sensor 132 of mobile robot 100 and fifth display area U210 is displayed, whereby the remote operator can identify a safe area by specifying, using a pointer or the like, a site that can be determined to be the safe area from the video displayed in fifth display area U210. Sixth display area U212 is an area that displays a left-side video with respect to mobile robot 100. Seventh display area U214 is an area that displays a right-side video with respect to mobile robot 100. Eighth display area U216 is an area that displays a rear-side video with respect to mobile robot 100. Sixth display area U212, seventh display area U214, and eighth display area U216 are, similarly to fifth display area U210, achieved by, for example, linkage with external sensor 132 of mobile robot 100.

Time period information U220 indicates the playback time period of the videos of the surroundings. Furthermore, sixth button U222 is a button that shifts the playback time of the videos forward. Similarly, seventh button U224 is a button that shifts the playback time of the videos backward. A safe area can be searched for by displaying the videos of the surroundings accumulated in management server 300 on overall UI area U200, but when there is no safe area in the videos in the display, a safe area can be searched for from videos of the surroundings from a different time by going further back in time or by shifting the playback time of the videos either forward or backward.

In this way, UI generator 330 generates, based on the surrounding information of mobile robot 100, a safe area identification UI used in obtaining information on a safe area. The safe area identification UI illustrated in FIG. 11 is an example of an obtaining UI.

Once again referring to FIG. 10, the description will be continued.

(S430) Presenter 514 of remote control terminal 500 receives the safe area identification UI via communicator 512, and presents the safe area UI received to the remote operator. Furthermore, input component 516 obtains, from the remote operator, input regarding the safe area identification UI presented. Thus, when a safe area is identified, information on the safe area is transmitted to mobile robot 100.

(S411) Reliability determiner 156 determines whether the current location of mobile robot 100 that was estimated by self-location estimator 134 is within the safe area. When it is determined by reliability determiner 156 that the current location is within the safe area, step S130 is proceeded to (see FIG. 17, described later). Furthermore, when it is determined by reliability determiner 156 that the current location is outside of the safe area, step S500 is proceeded to.

(S500) This has been omitted since it was described in the above text.

(S600) This has been omitted since it was described in the above text.

(S130) This has been omitted since it was described in the above text.

### 10 Second Sequence for Safe Area Identification Failure

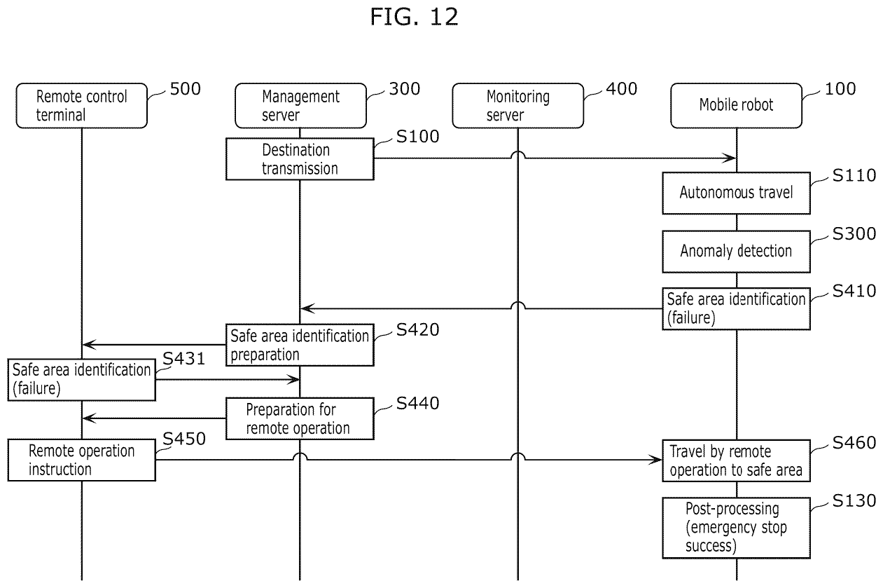

FIG. 12 is a second sequence diagram illustrating the operation of mobile robot control system 1 (the mobile robot control method) in the case of safe area identification failure, according to an embodiment. A sequence in which mobile robot 100 detects an anomaly while moving by autonomous travel to a destination and fails to identify a safe area within mobile robot 100, identification of a safe area with management server 300 or remote control terminal 500 also fails, and then mobile robot 100 moves to a safe area by travel by remote operation while searching for the safe area, is described with reference to FIG. 12.

(S100) This has been omitted since it was described in the above text.

(S110) This has been omitted since it was described in the above text.

(S300) This has been omitted since it was described in the above text.

(S410) This has been omitted since it was described in the above text.

(S420) This has been omitted since it was described in the above text.

(S431) Presenter 514 of remote control terminal 500 receives the safe area identification UI via communicator 512, and presents the safe area UI received to the remote operator. Furthermore, input component 516 obtains, from the remote operator, input regarding the safe area identification UI. When identification of a safe area fails, controller 510 notifies management server 300 of information indicating the safe area obtaining failure.

(S440) UI generator 330 of management server 300 receives the safe area obtaining failure via communicator 312, generates a second remote operation UI for searching for a safe area while performing travel by remote operation, and transmits the second remote operation UI to remote control terminal 500.

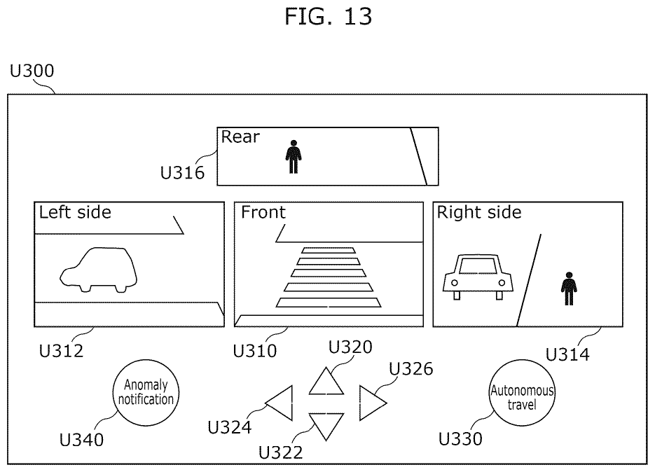

FIG. 13 is a diagram illustrating an example of the second remote operation UI according to the embodiment. U300 is the overall UI area presented on the monitor. Ninth display area U310 is an area that displays a front-side video with respect to mobile robot 100. By receiving a video from, e.g., a visible light camera with external sensor 132 of mobile robot 100 and displaying the video on ninth display area U310, the remote operator can confirm the state of the surroundings of mobile robot 100. Tenth display area U312 is an area that displays a left-side video with respect to mobile robot 100. Eleventh display area U314 is an area that displays a right-side video with respect to mobile robot 100. Twelfth display area U316 is an area that displays a rear-side video with respect to mobile robot 100. Tenth display area U312, eleventh display area U314, and twelfth display area U316 are, similarly to ninth display area U310, achieved by, for example, linkage with external sensor 132 of mobile robot 100.

Furthermore, eighth button U320 is a button that instructs mobile robot 100 to move forward. Similarly, ninth button U322, tenth button U324, and eleventh button U326 are buttons that give instructions to move to the rear, left, or right, respectively. The remote operator can perform remote operation of mobile robot 100 by pressing these buttons. Note that the instruction buttons for remote operation have been placed on the screen of overall UI area U300 that includes the display areas, but instructions for remote operation may be performed not on the screen of overall UI area U300, but using a different device that is connected to remote control terminal 500. As such a device, for example, a video game controller, a flight simulator operation device, or the like can be used as the device for remote operation.

Furthermore, twelfth button U330 is a button for giving an instruction to switch to autonomous travel. The remote operator checks ninth display area U310, tenth display area U312, eleventh display area U314, and twelfth display area U316, which display the front-side, rear-side, left-side, and right-side videos with respect to mobile robot 100, identifies a safe area, and then presses the button of twelfth button U330, whereby mobile robot 100 switches to autonomous travel and movement is performed.

Furthermore, thirteenth button U340 is a button for making a notification about an anomaly state. The remote operator compares the input of the movement instruction buttons of eighth button U320, ninth button U322, tenth button U324, and eleventh button U326 with the videos of the surroundings displayed in ninth display area U310, tenth display area U312, eleventh display area U314, and twelfth display area U316, and when the remote operator determines that there is an anomaly situation, the remote operator presses thirteenth button U340, which is the button for making a notification about an anomaly state, to notify management server 300 and mobile robot 100 about the anomaly.

Furthermore, the second remote operation UI may further have, in addition to the usage for remote operation, a suspicious activity reporting function (for example, thirteenth button U340) for, in a case of identifying suspicious activity regarding the movement of mobile robot 100, reporting the suspicious activity. In this case, controller 110 may stop mobile robot 100 at the current location when the input of the suspicious activity reporting function of the second remote operation UI is recognized (detected), while mobile robot 100 is being caused to move based on the input into the second remote operation UI on the server. When suspicious activity regarding movement is identified during movement of mobile robot 100 (for example, movement by remote operation), for example, when unauthorized control or the like is being performed, controller 110 is able to cause mobile robot 100 to stop at the current location (for example, to make an emergency stop). Note that thirteenth button U340, which is the button for making a notification about an anomaly state, being pressed is an example of an input of the suspicious activity reporting function of the remote operation UI being recognized (detected). Related operations will be described in the explanation of FIG. 17, described later.

Note that UI generator 330 may further generate a fourth alert UI for making a notification about the suspicious activity when the input of the suspicious activity reporting function of remote operation UI has been recognized. The fourth alert UI is presented to the remote operator by presenter 514. UI generator 330 is an example of a fourth UI generator.

Once again referring to FIG. 12, the description will be continued.

(S450) Presenter 514 of remote control terminal 500 receives the second remote operation UI via communicator 512, and presents the second remote operation UI received to the remote operator. Furthermore, input component 516 obtains, from the remote operator, input regarding the second remote operation UI presented. When operation information is inputted via input component 516, controller 510 transmits the operation information to mobile robot 100. Furthermore, when information on safe area information is inputted, controller 510 information transmits the information on safe area information to mobile robot 100.

(S460) When driver 138 of mobile robot 100 receives operation information from remote control terminal 500, driver 138 causes mobile robot 100 to move in accordance with the operation information. It can also be stated that controller 110 controls driver 138 to cause mobile robot 100 to move based on the information inputted into the remote operation UI on the server. Note that even during this movement, the second remote operation UI receives external sensor information and the like and is updated, and the remote operator can view the surrounding environment of mobile robot 100 in real-time.

Furthermore, when safe area obtainer 154 obtains information on a safe area based on information inputted into the remote operation UI, mobile robot 100 may continue to travel by remote operation as-is, or may switch to autonomous travel. FIG. 12 indicates the flow when travel by remote operation is continued, but on the other hand, when switching to autonomous travel, the reception of operation information ends, and driver 138 may perform travel autonomously, with the safe area as the destination.

(S130) This has been omitted since it was described in the above text.

### 11 First Sequence of Unsatisfactory Autonomous Travel Function Reliability

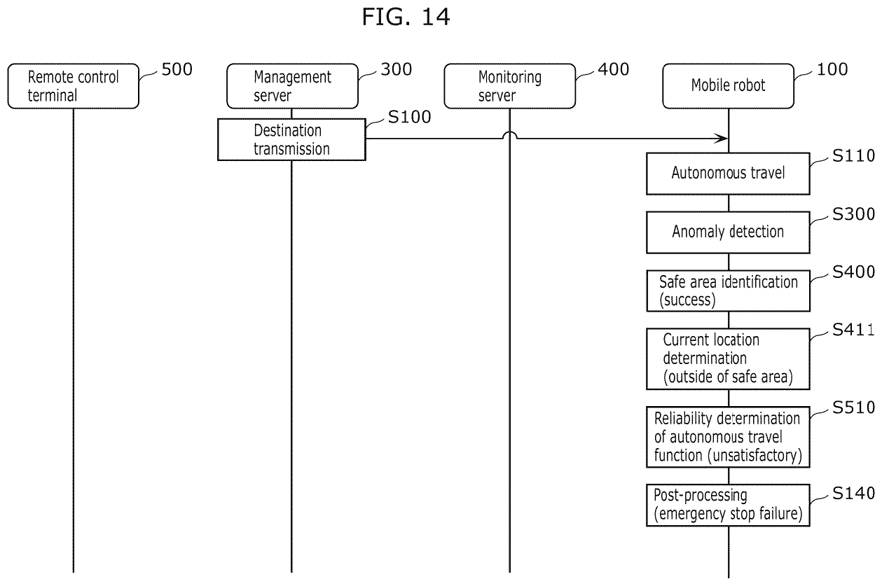

FIG. 14 is a first sequence diagram illustrating the operation of mobile robot control system 1 (the mobile robot control system) in the case of the autonomous travel function reliability being unsatisfactory, according to the embodiment. A sequence in which mobile robot 100 detects an anomaly while moving by autonomous travel to a destination, identifies a safe area, and then, when the reliability of the autonomous travel function is determined to be unsatisfactory, stops at the current location is described with reference to FIG. 14.

(S100) This has been omitted since it was described in the above text.

(S110) This has been omitted since it was described in the above text.

(S300) This has been omitted since it was described in the above text.

(S400) This has been omitted since it was described in the above text.

(S411) Reliability determiner 156 determines whether the current location of mobile robot 100 that was estimated by self-location estimator 134 is within the safe area. When it is determined by reliability determiner 156 that the current location is within the safe area, step S130 is proceeded to (see FIG. 17, described later). Furthermore, when it is determined by reliability determiner 156 that the current location is outside of the safe area, step S510 is proceeded to.

(S510) Reliability determiner 156 determines, from the anomaly state of autonomous travel function 130, whether autonomous travel function 130 is reliable in terms of performing autonomous travel. When reliability determiner 156 determines that there is a possibility that the anomaly state will affect autonomous travel function 130 and that autonomous travel is unreliable, step S140 is proceeded to.

(S140) Mobile robot 100 is unable to move to a safe area and stops at the current location. Mobile robot 100 notifies management server 300 about the emergency stop failure. Management server 300 generates an emergency stop failure notification UI and transmits the emergency stop failure notification UI to remote control terminal 500. Remote control terminal 500 presents the emergency stop failure notification UI. Typically, the emergency stop failure notification UI includes an alert indicating an emergency situation, and a display for measures to contact an assistance service or a contact function.

This makes it possible for assistance personnel (workers) to shortly arrive at the site of mobile robot 100, which is stopped at an unsafe area, and to prevent a dangerous situation by transporting mobile robot 100 or the like.

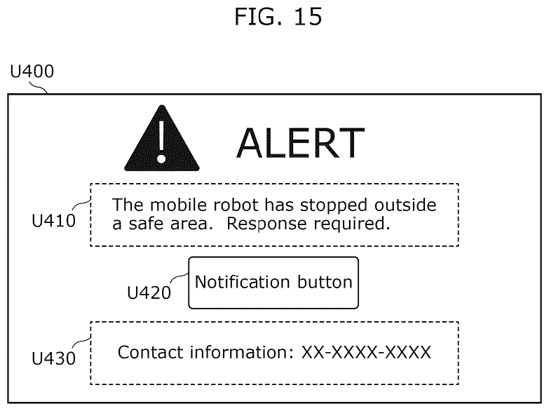

FIG. 15 is a diagram illustrating an example of an emergency stoppage failure notification UI according to an embodiment. U400 is the overall UI area presented on the monitor. Explanation area U410 is an area for explaining the situation regarding mobile robot 100. Fourteenth button U420 shows a notification button. When fourteenth button U420 is pressed, contact is automatically made with a contracted assistance service provider or the like, and workers come from the standby location of the assistance service provider closest to the site where mobile robot 100 is stopped to move mobile robot 100 to a safe area. The workers transport mobile robot 100 to move mobile robot 100 to a safe area. Contact information area U430 displays contact information for the police or the like. By contacting the police or the like, the remote operator performs safety considerations for the surrounding environment of mobile robot 100.

### 12 Second Sequence of Unsatisfactory Autonomous Travel Function Reliability

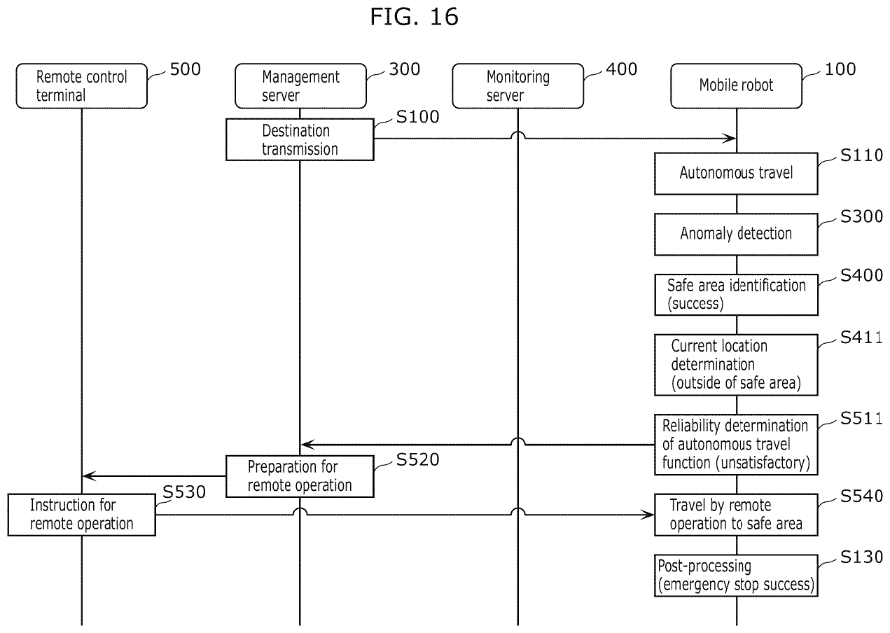

FIG. 16 is a second sequence diagram illustrating the operation of a mobile robot control system 1 (the mobile robot control system) in the case of the autonomous travel function reliability being unsatisfactory, according to an embodiment. A sequence in which mobile robot 100 detects an anomaly while moving by autonomous travel to a destination, identifies a safe area, and then, when the reliability of the autonomous travel function is determined to be unsatisfactory, moves by remote operation to the safe area while searching for the safe area with management server 300 and remote control terminal 500 is described with reference to FIG. 16.

(S100) This has been omitted since it was described in the above text.

(S110) This has been omitted since it was described in the above text.

(S300) This has been omitted since it was described in the above text.

(S400) This has been omitted since it was described in the above text.

(S411) Reliability determiner 156 determines whether the current location of mobile robot 100 that was estimated by self-location estimator 134 is within the safe area. When it is determined that the current location is within the safe area, step S130 is proceeded to (see FIG. 17, described later). When it is determined that the current location is outside of the safe area, step S511 is proceeded to.

(S511) Based on the detection result of detector 150, reliability determiner 156 determines, from the anomaly state of autonomous travel function 130, whether autonomous travel function 130 is reliable in terms of performing autonomous travel. When reliability determiner 156 determines that there is a possibility that the anomaly state will affect autonomous travel function 130 and that autonomous travel is unreliable, a notification of the unsatisfactory reliability determination is transmitted to management server 300.

(S520) When UI generator 330 of management server 300 receives the unsatisfactory reliability determination via communicator 312, UI generator 330 generates a second remote operation UI for searching for the safe area while performing travel by remote operation, and transmits the second remote operation UI to remote control terminal 500. In this way, when an anomaly in mobile robot 100 is detected while mobile robot 100 is moving autonomously and reliability determiner 156 determines that autonomous travel function 130 is unreliable, UI generator 330 generates a second remote operation UI (an example of the remote operation UI), to be used for the remote operation of mobile robot 100, in a server communicably connected to mobile robot 100 (for example, management server 300). UI generator 330 is an example of the third UI generator.

(S530) Presenter 514 of remote control terminal 500 receives the second remote operation UI via communicator 512, and presents the second remote operation UI received to the remote operator. Furthermore, input component 516 obtains, from the remote operator, input regarding the second remote operation UI presented. When operation information is inputted, controller 510 transmits the operation information to mobile robot 100. Furthermore, when information on safe area information is inputted, controller 510 information transmits the information on safe area information to mobile robot 100.

(S540) When driver 138 of mobile robot 100 receives operation information from remote control terminal 500, driver 138 causes mobile robot 100 to move in accordance with the operation information. It can also be stated that controller 110 causes mobile robot 100 to move to a safe area based on the input into the second remote operation UI on the server. Note that even during this movement, the second remote operation UI receives external sensor information and the like and is updated, and the remote operator can view the surrounding environment of mobile robot 100 in real-time. Furthermore, when information on a safe area is obtained, mobile robot 100 may continue to travel by remote operation as-is, or may switch to autonomous travel. FIG. 16 indicates the flow when travel by remote operation is continued, but on the other hand, when switching to autonomous travel, the reception of operation information ends, and driver 138 may perform travel autonomously, with the safe area as the destination.

(S130) This has been omitted since it was described in the above text.

### 13 Overall Flowchart of Mobile Robot 100

FIG. 17 is a flow chart illustrating the operation of mobile robot 100 (the mobile robot control method) according to the embodiment. (S110) This has been omitted since it was described in the above text.

(S120) This has been omitted since it was described in the above text.

(S130) This has been omitted since it was described in the above text.

(S140) This has been omitted since it was described in the above text.

(S300) When detector 150 of mobile robot 100 determines that, during autonomous travel, there has been unauthorized access to the system of mobile robot 100, e.g., there has been an unauthorized login into an account (“Yes” in S300), a notification is made to safe area obtainer 154 as an anomaly state and step S400/S410 is proceeded to. When no anomaly is detected (“No” in S300), step S120 is proceeded to, and post-processing is performed. Note that the determination in step S300 is performed in certain intervals of time during the autonomous travel of mobile robot 100, and when the determinations for each of the certain intervals of time are all “No”, step S120 is proceeded to.

(S400/S410) Safe area obtainer 154 attempts to obtain information on a safe area, based on the surrounding information obtained by external sensor 132. When safe area obtainer 154 was able to obtain information on a safe area (“Yes” in S400/S410), step S411 is proceeded to. Furthermore, when safe area obtainer 154 fails to obtain information on a safe area (“No” in S400/S410), safe area obtainer 154 transmits a notification of failure to obtain information on a safe area to management server 300, and step S900 is proceeded to.

(S411) Reliability determiner 156 determines whether the current location of mobile robot 100 that was estimated by self-location estimator 134 is within the safe area. When the current location of mobile robot 100 is within the safe area (“Yes” in S411), mobile robot 100 stops at the current location and step S130 is proceeded to. Furthermore, when the current location of mobile robot 100 is outside of the safe area (“No” in S411), step S500/S510 is proceeded to.

(S500/S510) Reliability determiner 156 determines, from the anomaly state of autonomous travel function 130, whether autonomous travel function 130 is reliable in terms of performing autonomous travel. When reliability determiner 156 has determined that autonomous travel function 130 is reliable (for example, in the case of step S500), reliability determiner 156 instructs driver 138 to autonomously travel to the safe area, and step S600 is proceeded to. Furthermore, when reliability determiner 156 determines that there is a possibility that the anomaly state will affect autonomous travel function 130 and that autonomous travel is unreliable (for example, in the case of step S511), reliability determiner 156 transmits a notification of the unsatisfactory reliability determination to management server 300, and step S540 is proceeded to.

(S540) This has been omitted since it was described in the above text.

(S600) This has been omitted since it was described in the above text.

(S900) When UI generator 330 of management server 300 receives, via communicator 312, the notification of failure to obtain information on a safe area, UI generator 330 generates a safe area identification UI used for identifying a safe area, and transmits the safe area identification UI to remote control terminal 500. Presenter 514 of remote control terminal 500 receives the safe area identification UI via communicator 512, and presents the safe area UI received to a monitor or the like. Furthermore, input component 516 obtains, from the remote operator, input regarding the safe area identification UI. In this way, when a safe area is identified (“Yes” in S900), information regarding the safe area is transmitted to mobile robot 100, and step S411 is proceeded to. On the other hand, when safe area identification fails (“No” in S900), the safe area identification failure is transmitted to management server 300, and step S540 is proceeded to.

(S910) During travel by remote operation in step S540, the remote operator compares the surrounding information presented in the second remote operation UI with the remote operation instructions inputted into the second remote operation UI, and when it is recognized, as a result, that the movement of mobile robot 100 is in a suspicious state, the remote operator presses thirteenth button U340, which is the button for making a notification about an anomaly state. When thirteenth button U340, which is the button for making a notification about an anomaly state, is pressed (“Yes” in S910), the second remote operation UI notifies management server 300 and mobile robot 100 of the anomaly, and step S140 is proceeded to. When the movement of mobile robot 100 is not in a suspicious state, thirteenth button U340, which is the button for making a notification about an anomaly state, is not pressed (“No” in S910), and travel by remote operation is continued.

### 14 Effects of Embodiment

The mobile robot control method according to the embodiment makes it possible to, in accordance with a security anomaly detected in a robot system and the current control state of a robot, analyze the cause of the security anomaly and select a safe control mode. The mobile robot control method is thus effective for achieving a safe robot system.

### 15 Other Embodiments

At least a part of the functional configuration of mobile robot 100 according to the foregoing embodiment may be achieved by management server 300 or monitoring server 400. Hereinafter, an example in which at least a part of the functional configuration of mobile robot 100 is included in management server 300 will be described.

Controller 310 may be able to perform at least a part of, or all of, the functions of controller 110. When controller 310 is able to perform at least a part of, or all of, the functions of controller 110, controller 310 is an example of a second controller. Furthermore, storage 314 may store at least a part of, or all of, the information stored in storage 116. When storage 314 stores at least a part of, or all of, the information stored in storage 116, storage 314 is an example of a second storage.

Furthermore, management server 300 may be able to perform at least a part of, or all of, the functions of detector 150. The processing component included in management server 300 that is able to perform at least a part of, or all of, the functions of detector 150 is an example of the anomaly detector. Furthermore, management server 300 may be able to perform at least a part of, or all of, the functions of safe area obtainer 154. The processing component included in management server 300 that is able to perform at least a part of, or all of, the functions of safe area obtainer 154 is an example of a second information obtainer. Furthermore, management server 300 may be able to perform at least a part of, or all of, the functions of reliability determiner 156. The processing component included in management server 300 that is able to perform at least a part of, or all of, the functions of reliability determiner 156 is an example of a second determiner.

For example, during autonomous travel of mobile robot 100, when an anomaly is detected in mobile robot 100 or when an anomaly is detected in mobile robot 100 and the second determiner has determined that autonomous travel function 130 is reliable, controller 310 that functions as the second controller may transmit control information to mobile robot 100 via communicator 312, the control information being for driver 138 to cause mobile robot 100 to move to a safe area based on information on the safe area. Furthermore, during autonomous travel of mobile robot 100, when an anomaly is detected in mobile robot 100 and the second information obtainer fails to obtain information on a safe area, controller 310 that functions as the second controller may cause mobile robot 100 to stop at the current location, or may cause the mobile robot to move based on the information inputted into the remote operation UI on the server.

At least a part of the functional configuration of management server 300 or monitoring server 400 according to the above embodiment may be achieved by mobile robot 100. Hereinafter, an example in which at least a part of the functional configuration of management server 300 is included in mobile robot 100 will be described.

Controller 100 may be able to perform at least a part of, or all of, the functions of UI generator 330. The processing component included in mobile robot 100 that is able to perform at least a part of, or all of, the functions of UI generator 330 is an example of a first UI generator or an example of the first UI generator and a second UI generator.

During autonomous travel of mobile robot 100, when an anomaly is detected and the first determiner determines that autonomous travel function 130 is unreliable, or when an anomaly is detected and the first information obtainer fails to obtain information on a safe area, the first UI generator generates a first alert UI for communicating an alert on a server (for example, management server 300) that communicably connects to mobile robot 100, and transmits the first alert UI generated to management server 300 via communicator 112.

During autonomous travel of mobile robot 100, when an anomaly is detected and the first determiner determines that autonomous travel function 130 is unreliable, the second UI generator generates a remote operation UI to be used for remote operation of mobile robot 100 on a server (for example, management server 300) that communicably connects to mobile robot 100, and transmits the remote operation UI generated to management server 300 via communicator 112. Furthermore, the remote operation UI generated by the second UI generator may further have, in addition to the usage for remote operation, a suspicious activity reporting function for, in a case of identifying suspicious activity regarding the movement of mobile robot 100, reporting the suspicious activity.

### Other Variations

Although the present disclosure has been described based on the aforementioned embodiments, the present disclosure is of course not limited to the embodiments discussed above. The present disclosure is also inclusive of the following cases.

(1) Although the foregoing embodiment did not specify a specific service and/or application for the robot system, the embodiment may be applied to any robot. For example, the robot may be a self-driving vehicle, a ship system, or a mobility robot such as a drone, or may be a robot that performs specific tasks, such as an industrial robot or a humanoid robot. The industrial robot may be a farm machine for use in agriculture, a construction machine for use in construction, or the like.

(2) Although the robot has two control methods, namely autonomous control and remote operation/control, in the foregoing embodiment, it is not absolutely necessary for two control means to be provided. For example, it is sufficient for at least two control methods to be provided, such as remote control and autonomous control. The control methods are furthermore not limited to these two methods. For example, the robot may have a cooperative control mode for operating cooperatively with another robot, a control mode for operating in response to commands from a control center, or the like.

(3) Although the foregoing embodiment described a mobile robot control system in which functions are divided between the management server and the monitoring server, the functions of the management server and the monitoring server may be combined.

(4) Although a remote operator conducted the remote operation in the foregoing embodiment, there may be personnel other than a remote operator who monitor the mobile robot control system. Examples may include the roles of a system administrator and a system operator, and the notification of the alert described in the foregoing embodiment, and the like may be transmitted to the system administrator and the system operator.

(5) Each device in the foregoing embodiments is specifically a computer system constituted by a microprocessor, ROM, RAM, a hard disk unit, a display unit, a keyboard, a mouse, and the like. A computer program is recorded in the RAM or hard disk unit. Each device realizes the functions thereof by the microprocessor operating in accordance with the computer program. Here, the computer program is constituted by a combination of a plurality of command codes that indicate commands made to a computer to achieve a predetermined function.

(6) Some or all of the constituent elements constituting the devices in the foregoing embodiments may be implemented by a single integrated circuit through system LSI (Large-Scale Integration). “System LSI” refers to very-large-scale integration in which multiple constituent elements are integrated on a single chip, and specifically, refers to a computer system configured including a microprocessor, ROM, RAM, and the like. A computer program is recorded in the RAM. The system LSI circuit realizes the functions thereof by the microprocessor operating in accordance with the computer program.

The parts of the constituent elements constituting the foregoing devices may be implemented individually as single chips, or may be implemented with a single chip including some or all of the devices.

Although the term “system LSI” is used here, other names, such as IC, LSI, super LSI, ultra LSI, and so on may be used, depending on the level of integration. Furthermore, the manner in which the circuit integration is achieved is not limited to LSI, and it is also possible to use a dedicated circuit or a generic processor. An FPGA (Field Programmable Gate Array) capable of post-production programming or a reconfigurable processor in which the connections and settings of the circuit cells within the LSI can be reconfigured may be used as well.

Further, if other technologies that improve upon or are derived from semiconductor technology enable integration technology to replace LSI circuits, then naturally it is also possible to integrate the function blocks using that technology. Biotechnology applications are one such foreseeable example.

(7) Some or all of the constituent elements constituting the foregoing devices may be constituted by IC cards or stand-alone modules that can be removed from and mounted in the apparatus. The IC card or module is a computer system constituted by a microprocessor, ROM, RAM, and the like. The IC card or module may include the above very-large-scale integration LSI circuit. The IC card or module realizes the functions thereof by the microprocessor operating in accordance with the computer program. The IC card or module may be tamper-resistant.

(8) The present disclosure may be realized by the methods described above. This may be a computer program that implements these methods on a computer, or a digital signal constituting the computer program. For example, one aspect of the present disclosure may be a computer program that causes a computer to execute each characteristic step included in the mobile robot control method indicated in any one of FIG. 6, FIG. 7, FIG. 9, FIG. 10, FIG. 12, FIG. 14, FIG. 16, or FIG. 17.

Additionally, the present disclosure may also be computer programs or digital signals recorded in a computer-readable recording medium such as a flexible disk, a hard disk, a CD-ROM, an MO, a DVD, a DVD-ROM, a DVD-RAM, a BD (Blu-ray (registered trademark) Disc), semiconductor memory, or the like. The constituent elements may also be the digital signals recorded in such a recording medium.

Additionally, the present disclosure may be realized by transmitting the computer program or digital signal via a telecommunication line, a wireless or wired communication line, a network such as the Internet, a data broadcast, or the like.

Additionally, the present disclosure may be a computer system including a microprocessor and memory, where the memory records the above-described computer program and the microprocessor operates in accordance with the computer program.

Additionally, the present disclosure may be implemented by another independent computer system, by recording the program or the digital signal in the recording medium and transferring the recording medium, or by transferring the program or the digital signal over the network or the like.

(9) The order in which the steps in the flow chart are executed is simply an order exemplified for specifically describing the present disclosure, and the order may be different from that described above. Furthermore, some of the above-described steps may be executed simultaneously (in parallel) with other steps, and some of the above-described steps may not be executed. (10) Additionally, the divisions of the function blocks in the block diagrams are merely examples, and a plurality of function blocks may be realized as a single function block, a single function block may be divided into a plurality of function blocks, or some functions may be transferred to other function blocks. Additionally, the functions of a plurality of function blocks having similar functions may be processed by a single instance of hardware or software, in parallel or time-divided.

(11) The above-described embodiments and variations may be combined as well. Moreover, variations on the present embodiment conceived by one skilled in the art, embodiments implemented by combining constituent elements from different other embodiments, and the like may be included as well in the present disclosure as long as they do not depart from the essential spirit of the present disclosure.

### INDUSTRIAL APPLICABILITY

The present disclosure is useful for ensuring safety when a security anomaly occurs while a mobile robot is moving, in a mobile robot control system.

1. A mobile robot that is capable of autonomous movement, the mobile robot comprising:
a first information obtainer that, when an anomaly in the mobile robot is detected during autonomous movement of the mobile robot, obtains information on a safe area identified based on a state of surroundings of the mobile robot, the safe area being an area at which the mobile robot can stop; and
a first controller that, when an anomaly in the mobile robot is detected during autonomous movement of the mobile robot, causes the mobile robot to move to the safe area based on the information on the safe area.

2. The mobile robot according to claim 1, wherein
when, during autonomous movement of the mobile robot, the anomaly is detected and the first information obtainer fails to obtain the information on the safe area, the first controller causes the mobile robot to stop at a current location.

3. The mobile robot according to claim 2, further comprising:
a first user interface (UI) generator that generates a first alert UI when, during autonomous movement of the mobile robot, the anomaly is detected and the first information obtainer fails to obtain the information on the safe area, the first alert UI being for communicating an alert on a server that communicably connects to the mobile robot.

4. The mobile robot according to claim 3, wherein
the first UI generator generates an obtaining UI used for obtaining the information on the safe area, based on surrounding information that is information on the surroundings of the mobile robot.

5. The mobile robot according to claim 4, wherein
the surrounding information includes sensor information obtained by a sensor provided to the mobile robot.

6. The mobile robot according to claim 4, wherein
the surrounding information includes video information obtained by a camera provided to the mobile robot.

7. The mobile robot according to claim 4, wherein
the surrounding information includes current location information that is information on a current location of the mobile robot, the current location information being obtained by a sensor provided to the mobile robot.

8. The mobile robot according to claim 4, wherein
the surrounding information includes map information stored beforehand by the server.

9. The mobile robot according to claim 3, wherein
the first UI generator further generates a remote operation UI used for at least one of operating the mobile robot remotely or specifying the information on the safe area,
the first controller causes the mobile robot to move based on information inputted into the remote operation UI on the server, and
the first information obtainer obtains the information on the safe area, the information on the safe area being based on the information inputted into the remote operation UI.

10. A server for controlling a mobile robot capable of autonomous movement, the server comprising:
a second information obtainer that, when an anomaly in the mobile robot is detected during autonomous movement of the mobile robot, obtains information on a safe area identified based on a state of surroundings of the mobile robot, the safe area being an area at which the mobile robot can stop; and
a second controller that, when an anomaly in the mobile robot is detected during autonomous movement of the mobile robot, causes the mobile robot to move to the safe area based on the information on the safe area.

11. The server according to claim 10, wherein
when, during autonomous movement of the mobile robot, the anomaly is detected and the second information obtainer fails to obtain the information on the safe area, the second controller causes the mobile robot to stop at a current location.

12. The server according to claim 11, further comprising:
a second user interface (UI) generator that generates a second alert UI when, during autonomous movement of the mobile robot, the anomaly is detected and the second information obtainer fails to obtain the information on the safe area, the second alert UI being for communicating an alert.

13. The server according to claim 12, wherein
the second UI generator generates an obtaining UI used for obtaining the information on the safe area, based on surrounding information that is information on the surroundings of the mobile robot.

14. The server according to claim 13, wherein
the surrounding information includes sensor information obtained by a sensor provided to the mobile robot.

15. The server according to claim 13, wherein
the surrounding information includes video information obtained by a camera provided to the mobile robot.

16. The server according to claim 13, wherein
the surrounding information includes current location information that is information on a current location of the mobile robot, the current location information being obtained by a sensor provided to the mobile robot.

17. The server according to claim 13, wherein
the surrounding information includes map information stored beforehand by the server.

18. The server according to claim 12, wherein
the second UI generator further generates a remote operation UI used for at least one of operating the mobile robot remotely or specifying the information on the safe area,
the second controller moves the mobile robot based on information inputted into the remote operation UI on the server, and
the second information obtainer obtains the information on the safe area, the information on the safe area being based on the information inputted into the remote operation UI.

19. A mobile robot control method for controlling a mobile robot capable of autonomous movement, the mobile robot control method comprising:
causing the mobile robot to move to a safe area, based on information on the safe area, when an anomaly in the mobile robot is detected during autonomous movement of the mobile robot, the safe area being an area at which the mobile robot can stop and being identified based on a state of surroundings of the mobile robot.
